(19) United States
(12) Patent Application Publication
(10) Pub. No.: US 2015/0242883 A1
(43) Pub. Date: Aug. 27, 2015

(54) ELECTRONIC COUPON SYSTEM

(71) Applicant: R.J. Reynolds Tobacco Company, Winston-Salem, NC (US)

(72) Inventors: Joel R. Setchell, Advance, NC (US); Cary Jennings, Winston-Salem, NC (US)

(21) Appl. No.: 14/187,852

(22) Filed: Feb. 24, 2014

(51) Int. Cl. G06Q 30/02

(52) U.S. Cl. CPC G06Q 30/0238; G06Q 30/0236; G06Q 30/0224

(57) ABSTRACT

Systems and methods are provided for improved electronic coupon distribution. A coupon rule may be determined based on the user data and an electronic coupon may be sent to a mobile device, where the electronic coupon may be selected based on the coupon rule. A first message may be received, where the first message confirms that the user redeemed the electronic coupon at a point of sale system to purchase the product. A second message may be sent to the mobile device, where the second message may specify a limitation on further use of the electronic coupon.

### BACKGROUND

The present disclosure generally relates to improved electronic coupon systems.

### SUMMARY

The present disclosure provides systems and methods for improved electronic coupon distribution. In some implementations, a method includes receiving user data from a mobile device and registering a user into a loyalty program based on the user data. The method may further include sending to the mobile device an electronic coupon that is selected based on a coupon rule, the electronic coupon being associated with a product. A first message may be received confirming that the user redeemed the electronic coupon at a point of sale system to purchase the product. Further, a second message may be sent to the mobile device specifying a limitation on further use of the electronic coupon.

In some implementations, a computer implemented system may be provided that includes receiving user data from a mobile device and register the user into a loyalty program based on the user data. A coupon rule may be determined based on the user data. The mobile device may send an electronic coupon, where the electronic coupon may be selected based on the coupon rule. A first message may be received, where the first message confirms that the user redeemed the electronic coupon at a point of sale system to purchase a product. A second message may be sent to the mobile device, where the second message may specify a limitation on further use of the electronic coupon.

In some implementations, a non-transitory computer readable medium may include instructions for distributing and/or processing electronic coupons. User data and the user may be registered into a loyalty program based on the user data. An electronic coupon may be sent to a mobile device, where the electronic coupon may be selected based on a coupon rule. A first message may be received, where the first message confirms that the user redeemed the electronic coupon at a point of sale system to purchase the product. A second message may be sent to the mobile device, where the second message may specify a limitation on further use of the electronic coupon. The second message may provide notice to the user that the coupon is used, notice that the coupon expires, a message of thanks to the user for the purchase, or notice of future coupons or incentives.

Further objects, features and advantages of this application will become readily apparent to persons skilled in the art after a review of the following description, with reference to the drawings and claims that are appended to and form a part of this specification.

### BRIEF DESCRIPTION OF THE DRAWINGS

The drawings described herein are for illustration purposes only and are not intended to limit the scope of the present disclosure in any way.

FIG. 1 is a schematic view of an electronic coupon system.

FIG. 2 is a flowchart illustrating a method of redeeming an electronic coupon.

FIG. 3 is a flowchart illustrating a method of distributing electronic coupons.

FIG. 4 is an illustration a computer system that may be used in the systems and methods of the present disclosure.

It should be understood that throughout the drawings, corresponding reference numerals indicate like or corresponding parts and features.

### DETAILED DESCRIPTION

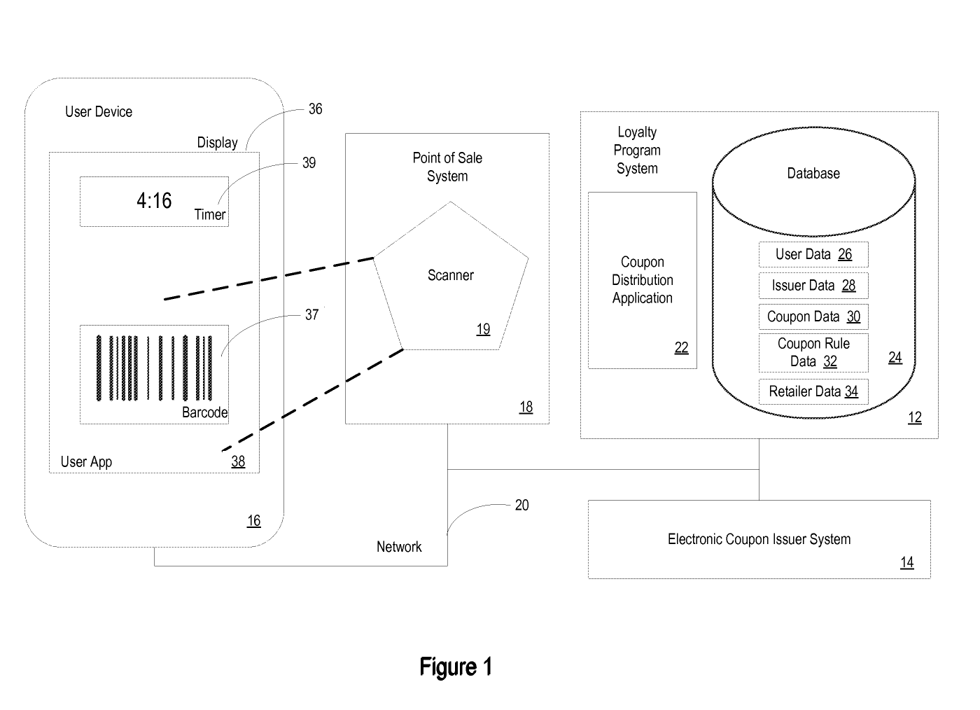

FIG. 1 illustrates an electronic coupon system 10 that may be implemented in a networked environment. The networked environment may include a loyalty program system 12, an electronic coupon issuer system 14, a user device 16, and/or a point of sale system 18. Although FIG. 1 shows only one loyalty program system 12, one electronic coupon issuer system 14, one user device 16, and one point of sale system 18, in some implementations the electronic coupon system 10 may include a plurality of each component. In some instances, a coupon may be a message from a source, such as a manufacturer, retailer, wholesaler, etc, to a consumer including one or more of a discount, reward, promotion, incentive, or offer normally redeemed with a retailer for goods or services requiring action on the part of the user. The action may include purchase of an item or providing certain consumer data of the user. The consumer data may include information identifying the user, the user's finances, the user's preferences, and/or the user's purchasing habits. The consumer data may also include the time, date, place, and price related to the purchase. For example, the electronic coupon may be access to a particular offer, such as a discount or special price on a product, good, or service. The product may be a consumer product, such as drinks (e.g. water or soda), snacks, tobacco products, confectionaries, etc. The consumer products may be offered to the public and coupons redeemed through various retailers, including for example convenience stores. In some instances an electronic coupon may be a link to a website, an email, a text, or available in other electronic mediums, further, electronic coupon may be delivered through an electronic medium and printed for redemption purposes. The electronic coupon may be non-paper, digital, coded (e.g. bar coded), scrambled, in received message form, in the form of an ID entered by a clerk, scanned, or provided on an RFID, memory stick, electronic image, or other media. The electronic coupon may be redeemed during purchase. A purchase may include tender of currency or barter for acquisition of a good and service. Each of the components of the networked environment 10 may be in communication with each other via one or more networks 20, which may include the Internet, intranets, extranets, wide area networks (WANs), local area networks (LANs), wired networks, wireless networks, or other suitable networks, etc., or any combination of such networks. The loyalty program system 12 and the electronic coupon issuer system 14 may each comprise a computing device, such as a server computer or any other system providing computing capability. Moreover, each of the loyalty program system 12 and the electronic coupon issuer system 14 may comprise a plurality of computing devices that may be arranged in one or more server banks or computer banks. For example, a plurality of computing devices together may comprise a cloud computing resource, a grid computing resource, and/or any other distributed computing arrangement. Such computing devices may be located in a single installation or may be distributed among many different geographical locations.

The electronic coupon issuer system 14 may be implemented by an electronic coupon issuer, which may be the manufacturer of goods or provider of services that are associated with the electronic coupon and for which discounts are given by way of the electronic coupon. The electronic coupon issuer system 14 may generate electronic coupons for associated products or services. The electronic coupon issuer system 14 may also generate coupon rules (e.g. targeting criteria) for distribution of the electronic coupons tailored for redemption by specific users. The coupon rules may also define various properties, parameters, and/or restrictions associated with an electronic coupon funded by the electronic coupon issuer, as will be discussed in more detail.

The loyalty program system 12 may operate a loyalty program as follows. The loyalty program system 12 may store and may be configured to execute various applications such as a coupon distribution application 22 that facilitates distribution and redemption of electronic coupons. In some implementations, the loyalty program system 12 may also have the capabilities described above of the electronic coupon issuer system 14. In such implementations, the electronic coupon issuer may operate the loyalty program system 12, for example. The coupon distribution application 22 may receive coupon rules that are transmitted from the electronic coupon issuer system 14, for example as a data file. In some implementations, the coupon distribution application 22 may also generate coupon rules rather than or in addition to the electronic coupon issuer system's 14 generation of coupon rules. The coupon distribution application 22 may communicate with the electronic coupon issuer system 14, user device 16, and/or the point of sale system 18 via user interfaces in browsers executed in corresponding computing devices. Additionally, they may communicate with the coupon distribution application 22 via application programming interfaces (API's) provided by the coupon distribution application 22. For example, the coupon distribution application 22 can provide a web service API with which point of sale systems 18 may communicate in order to facilitate redemption of electronic coupons.

The loyalty program system 12 may include at least one database 24 (e.g. loyalty profile database) associated with the manufacturer of goods or provider of services. A loyalty program may be a structured marketing effort that rewards loyal buying behavior. For example, a retailer, wholesaler, or manufacturer may offer to a consumer an incentive to capture purchases and/or generate future promotions. The user may receive an account or ID that identifies the purchaser as a member in the loyalty program. The purchaser is typically entitled to either a discount on the current purchase, or an allotment of points that can be used for future purchases. Users enroll into the retailer's loyalty program by providing personal information (name, age, address, etc). Using the loyalty program account in conjunction with a purchase or transaction captures specific purchases for a specific user. These data elements may be applied to coupon rules for coupon distribution.

The database 24 may be accessible to the coupon distribution application 22. The database 24 may comprise data and applications operable to provide access to the data stored therein. The database 24 may or may not reside within the loyalty program system 12, but may be accessible via a network to the loyalty program system 12. The database 24 may store user data 26, issuer data 28, coupon data 30, coupon rule data 32, and retailer data 34. The database 24 may be implemented in a separate computing device that may be located in a separate installation or location. The database 24 may be implemented in a single table structure, or in a plurality of separate table structures for each of the user data 26, issuer data 28, coupon data 30, coupon rule data 32, and retailer data 34, for example. The coupon distribution application 22 may extract data from the one or more table structures by querying the database 24.

The user data 26 may be associated with user accounts (e.g. user loyalty profiles) of users of the coupon distribution application 22. The user data 26 may include user profile data, which can include demographic information about a user, shipping addresses, telephone numbers, payment information, e-mail addresses, purchasing history, product browsing history, electronic coupon usage history, product preferences selected by the user, affinity groups with which the user is affiliated, user devices 16 registered to the user, and other data related to users. The user data 26 may also include data regarding electronic coupons presently associated with a user account. The user data 26 may also include marketing information that is imported into the data store 24 such as from a marketing database.

The issuer data 28 may include data regarding electronic coupon issuer of the electronic coupon issuer systems 14. The issuer data 28 may include profile data regarding an electronic coupon issuer, such as data regarding payments for coupon campaigns, products or services sold by the electronic coupon issuers that are available for redemption via electronic coupons, and/or electronic coupons issued by and associated with the coupon issuer.

The coupon data 30 may include information regarding one or more individual electronic coupons that are specified by an electronic coupon issuer. The information may include one or more product identifiers associated with the electronic coupon. A product identifier may include a universal product code, a model number, a serial number, or any other identifier that can uniquely identify a product or a class of products. The information may associate an electronic coupon with a bundle of products by including information on multiple products. Thus, purchase of multiple products may be necessary to redeem that electronic coupon. The information may also include a promotion associated with the electronic coupon, for example the discount amount the electronic coupon issuer may reimburse to a point of sale system 18, a complimentary or discounted product provided is association with a particular product, and other coupon promotions. A discount amount may include a fixed amount, a percentage of a selling price, and/or a percentage of a manufacturer's suggested retail price. The information may also specify an electronic coupon expiration date and/or a maximum amount an electronic coupon issuer is willing to reimburse point of sale system 18 operators in connection with an that particular electronic coupon or with all electronic coupons. The information may also include a coupon issuer identifier or tracking number, which can be used by an electronic coupon issuer to track metrics such as redemption rate.

The coupon rule data 32 may include coupon rules, which may be stored with the coupon data 30 (e.g. coupon rules associated with an individual coupon are stored with that individual coupon) or be stored separately from the coupon data 30. The coupon rules associated with an electronic coupon or with a plurality of electronic coupons may define requirements for users to whom an electronic coupon should be made available by the coupon distribution application 22. The coupon rules may further include retailer restrictions, which can limit the point of sale systems 18 with which an electronic coupon is eligible to be redeemed. For example, an electronic coupon issuer communicating with the coupon distribution application 22 via an electronic coupon issuer system 14 may limit electronic coupon distribution to authorized retailers of a product sold by the electronic coupon issuer (e.g. to retailers serving a desired demographic). The coupon distribution application 22 may also define and/or continuously update or revise coupon rules by generating coupon and/or product recommendations based on the user data 26 and retailer data 34. For example, the user data 26 may facilitate selecting (e.g. targeting) of electronic coupons to specific users based upon a purchase history, browse history, demographic information (e.g. age, sex, income level, location), or other information, and other user data 26. Electronic coupons may also be targeted towards members of a specific affinity group and/or membership club. Thus, the coupon distribution application 22 may make the electronic coupons available to the user device 16 based on the coupon rules.

The retailer data 34 may include data regarding point of sale systems 18. Retailer data 34 may include information regarding redemptions of electronic coupons issued by the coupon distribution application 22 by users with various retailers. The retailer data 34 may include a volume of redeemed coupons, an account balance associated with a retailer, data regarding a fraud history, data regarding products available via a particular retailer, for example. Additionally, retailer data 34 may specify an identity of various point of sale systems 18 that may be associated with a retailer, and/or may specify the identify of a retailer associated with a plurality of point of sale systems 18. The retailer data 34 may also include information about coupon redemptions at the point of sale system 18 as well as information regarding enforcement of electronic coupon restrictions.

The user device 16 may communicate with the coupon distribution application 22. The user device 16 may comprise a computing device. The computing device may be a computer system such as a desktop, laptop, mobile device, tablets, phablets, smartphones, wearable computers, (e.g. glasses or wristwatches) or other computing devices with similar capabilities. The mobile device may be a cell phone, personal digital assistant, or other mobile device with similar capabilities. The user device 16 may also include a display 36. The display 36 may display various user interfaces generated by the user application 38 and/or coupon distribution application 22 in connection with implementing an electronic coupon system. For example, the user device 16 may interface with the loyalty program system 12 by executing various user applications 38. One such user application 38 may be a browser application configured to load a network page containing an electronic coupon user interface (e.g. a picture of a paper coupon, an interactive display of the electronic coupon, a representation of the electronic coupon). In each example of the electronic coupon user interface, the electronic coupon user interface may display a logo of a manufacturer or provider company, a logo of a product or service, the discount or deal being offered, and/or description of the discount or deal, for example. Another such user application 38 may be a dedicated application (e.g. that may be purchased, downloaded, and/or installed on the user device 16). If the user device 16 is a mobile device, then the dedicated application may be a mobile application (e.g. that may be purchased, downloaded, and/or installed on the user device 16 by the user from a mobile application store) that is tailored to access and communicate with the coupon distribution application 22. The display 36 may display electronic coupon user interfaces for electronic coupons that were determined and/or recommended by the coupon distribution application 22 based on the coupon rules. The displayed electronic coupon user interface may include graphical identifier, such as a bar code, or other identifier identifying the electronic coupon. For example, the identifier may a code including alpha and/or numeric characters that are inputted into the point of system by the retailer. It is also contemplated that other electronic methods may be utilized for coupon distribution including, but not limited to, a file download, website link, email, text message, or a notification within an application.

The coupon distribution application 22 may generate, and distribute or “push”, over the network 20, electronic coupon data (e.g. electric coupons) to the user application 38 for publication and use. The user application 38 and/or the coupon distribution application 22 may generate a user interface on the display 36 of the user device 16 to facilitate interaction with the various systems or components of the loyalty program system 12. Thus, users may use the user application 38 to interact with the coupon distribution application 22 to view and use electronic coupons provided by the coupon distribution application 22.

The user may use the user device 16 (e.g. the user application 38) to register a user account (e.g. user loyalty profile) in the database 24. To do so, the user may first obtain, from a retailer or an electronic coupon issuer, a membership card (e.g. loyalty card) of an electronic coupon issuer (e.g. manufacturer of goods or provider of services). The membership card may be a physical card obtained from a physical retailer or an electronic card obtained online, for example. The membership card may have one or more of a unique identification number, a pin number, and a security number. The user may then input the unique identification number, a pin number, and/or a security number into the user application 38 to register. The user may also input user data into the user application 38, such as one or more of social security number (e.g. last four digits of social security number), product preferences, name, phone number, demographic information (e.g. age or data of birth, gender, income level, and geographical location including address and/or region).

The user may also be required (e.g. prompted) to certify that the user is old enough to obtain electronic coupons for certain age-restricted products such as tobacco products. The inputted information may be sent back to the loyalty program system 12 (e.g. to the coupon distribution application 22) for validation and for age verification. If the entered information is valid and if the user's age is a valid age (e.g. satisfying an age criterion, or above an age threshold value such as twenty-one years or older), the user may be registered with a user account (e.g. user loyalty profile) which may be stored among the user data 26 of the database 24. The loyalty program system 12 (e.g. to the coupon distribution application 22) may then send a command back to the user application 38 to confirm registration of the user and provide the user application 38 access to electronic coupons. If the user's credentials are invalid, then the coupon distribution application 22 and/or the user application 38 may deny registration of the user. If the user's credentials are valid but the user's age is not valid (e.g. the user's age does not satisfy an age criterion, or the user's age is less the threshold value), then the coupon distribution application 22 and/or the user application 38 may deny registration of the user, or in other implementations, may register the user but restrict access to electronic coupons for certain products (e.g. tobacco products) to users not having the valid age (e.g. not satisfying the age criterion, or below the age threshold. However, except for excluding access to restricted products, the electronic coupon system 10 may otherwise operate fully as described herein, including operation of coupon rules to generate targeted electronic coupons for non-restricted, allowed products.

Once registered, the user may use the user application 38 of the user device 16 to redeem the electronic coupons at the point of sale system 18. The user may login to the user application 38 and select to view electronic coupons that are targeted to the user based on the coupon rules. Additionally, the user may search for nearby stores that are offering products for which electronic coupons are being offered by the user application 38, and/or nearby stores that are redeeming electronic coupons offered by user application 38. The user may search for the nearby stores by city or by zip code, for example. The list of electronic coupons that are redeemable at nearby stores may also include and/or be limited to the electronic coupons targeted to the user based on the coupon rules.

Once the user selects a manner in which to search for or to receive alerts of available electronic coupons, the display 36 may display a list of electronic coupons, and/or a plurality of electronic coupon user interfaces (e.g. pictures of paper coupons, representations of electronic coupons). If the user selects an entry in the list of electronic coupons and/or one of the electronic coupon user interfaces, the user application 38 may display on the display 36 a graphical or textual identifier 37 associated with the selected electronic coupon. The graphical or textual identifier 37 may be scanned or inputted (e.g. may be a bar code that may be scanned by a scanner 19) into a point of sale system 18. A timer 39 displaying a countdown time period (e.g. 5 minutes, 10 minutes, 15 minutes, between about 5 and about 15 minutes) may begin during which the user may be permitted to allow the point of sale system 18 to scan the coupon.

The point of sale system 18 may comprise a third party retailer system operated by a third party retailer. In some implementations, the third party retailer system may include a computing device operatively connected to a check-out station or a scanner 19 (e.g. bar-code scanner operated by a cashier) at a retail outlet or store, for example. In other implementations, the third party retailer system may be an electronic commerce system which may, for example, sell products or services via the Internet or other network. A retailer may operate numerous point of sale systems 18 that can interact with the coupon distribution application 22. The user may attempt to redeem an electronic coupon by displaying the graphical or textual identifier (e.g. bar code) and having the identifier scanned or entered into the point of sale system 18 (e.g. check out station or bar code scanner that scans the bar code). In some implementations, the mobile device 16 may communicate wirelessly with the point of sale system 18 according to a wireless networking protocol to facilitate redemption of the electronic coupon. In response to the user's attempt to redeem the electronic coupon, the user application 38 will interact with (e.g. send information back to) the coupon distribution application 22 to authenticate the user's credentials and validate the electronic coupon.

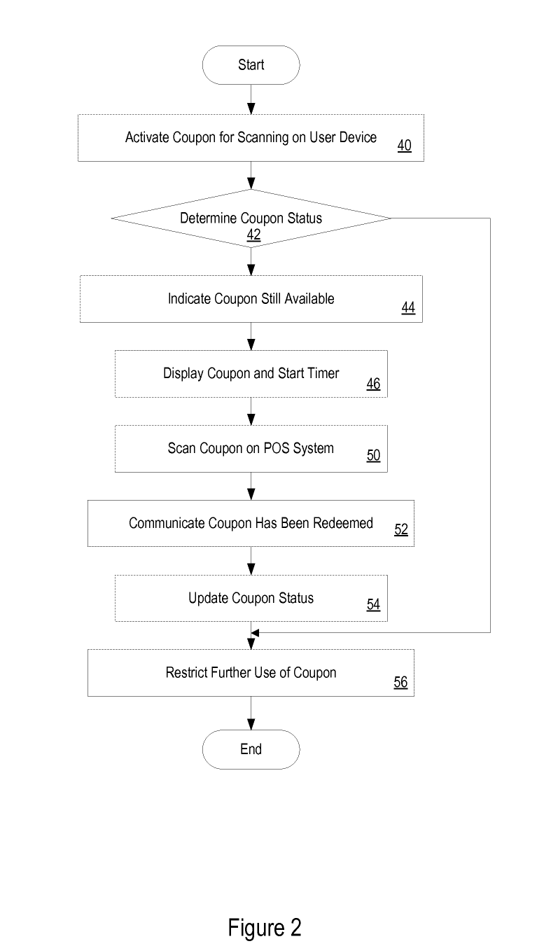

Now referring to FIG. 2, one example of a method for redeeming coupons is provided. The user may select activation of the coupon for scanning, in block 40. The user application 38 may communicate with coupon distribution application 22 to determine if the coupon has already been redeemed or is available for use. The coupon distribution application 22 may access the database 24 to determine the status of the coupon, in block 42. If the coupon is not available for use, the system may restrict further use of the coupon, as denoted by block 56. If the coupon is still available, the coupon distribution application 22 may provide an indication that the coupon is still available for use to the user application 38, as denoted by block 44. Further, the user application 38 may display the coupon on the display 36 and/or start a timer, in response to the indication that the coupon is still available for use, as denoted by block 46. In block 50, the coupon may be presented to the POS system 18 for scanning, for example before the timer expires. The coupon may be removed from the display after the time is expired. In response to the expiration of the timer, the user application 38 may request that the coupon be invalidated or, in some implementations, the coupon may be made available for use if it has not been redeemed. In response to the scanning, the POS system 18 may communicate with the coupon distribution application 22 through the network 20 to indicate that the coupon has been redeemed, as denoted by block 52.

In block 54, the coupon distribution application 22 may update the coupon status in the database 24, in response to the indication that the coupon has been redeemed. In addition, the coupon distribution application 22 may also communicate with the user application 38, in response to the communication from the POS system 18, indicating the coupon has been redeemed. The user application 38 may then restrict the use of the coupon in response to the indication of redemption, as denoted by block 56. For example, the user application 38 may stop displaying the coupon and/or delete the coupon upon receipt of the indication of redemption. The system may be configured to perform the communication between the user application 38, the coupon distribution application 22, and the POS system 18 in real time such that the coupons can only be redeemed once. Further, the system may identify if the coupon has been redeemed multiple times and generate a message indicating the multiple redemptions. In some implementations, the message may be sent to an administrator, the POS system and/or the user in response to the multiple uses. The user application 38 may also be disabled in response to the multiple uses.

The coupon distribution application 22 may also receive messages comprising purchase confirmations and/or settlement requests from user applications 38 and/or point of sale systems 18 in connection with purchases made by users for which a electronic coupon issued by the coupon distribution application 22 to the user were used. The purchase confirmation may include a shipment confirmation and/or shipment tracking data associated with the purchase using the electronic coupon. In response, the coupon distribution application 22 may then issue reimbursements from the electronic coupon issuer to the third-party retailers for discounts or other promotions designated by the electronic coupon. The coupon distribution application 22 may also generate reporting metrics for an electronic coupon issuer that includes various statistics and information regarding electronic coupon redemption, user purchasing history, user browsing history, etc. The coupon distribution application 22 may generate an invoice from an electronic coupon issuer in connection with reimbursements paid to the third-party retailer. The coupon distribution application 22 may also update the database 24 based on the new purchase, for example by updating the user data 26, issuer data 28, coupon rule data 30, coupon rule data 32, and/or retailer data 34 with new information associated with the purchase. For example, as discussed earlier, coupon rules are logic that may be used to dynamically update targeted coupon distribution to specific users. The coupon rules may employ various thresholds, Boolean comparisons, fuzzy logic or other algorithms on a wide variety of data for making distribution decisions. For example, the coupon rules may be dynamically based on the user data. For example, when the user uses the electronic coupon, point-of-sale information is sent from the mobile application 38 to the coupon distribution application 22. Based on the point-of-sale information, the coupon distribution application 22 may update the user's loyalty profile to include information regarding the purchase made by the user, and may also generate and revise coupon rules for use by the coupon distribution application 22 and/or mobile application 38 in deciding which coupons to provide to the user on the mobile device 16. Thus, the point-of-sale information in the loyalty profiles and the coupon rules are continually updated, based on the user's past preferences, age, and all other relevant information, as discussed earlier.

After information about a purchase is provided to the loyalty program system 12 (e.g. to the coupon distribution application 22) from the user device 16 (e.g. from user application 38), the loyalty program system 12 (e.g. to the coupon distribution application 22) may send a message back to the user device 16 (e.g. from user application 38). The message may provide the updated user data 26, issuer data 28, coupon rule data 30, coupon rule data 32, and/or retailer data 34 to the mobile application 38 to cross-reference with the data in the mobile application 38 and to eliminate discrepancies between to two. In particular, the message may specify that the redeemed coupon cannot be provided or used again, and/or may specify limitations on further use of the electronic coupon such as by specifying that the electronic coupon is to expire or that a number of uses available for the electronic coupon is to decrease. The message may also include a report of redeemed and available electronic coupons such that the user application 38 and its database of available electronic coupons may be synchronized with the database 24 of the loyalty program system 12. Thus, the message may confirm the availability of the electronic coupons. The message may thus prevent fraud by the user and/or user application 38.

In some implementations, the product offered by the electronic coupon issuer (e.g. manufacturer) may be a tobacco product. Cigarettes, cigars and pipes are popular smoking articles that employ tobacco in various forms. For example, a traditional type of cigarette has a substantially cylindrical rod-shaped structure and includes a charge, roll or column of smokable material, such as shredded tobacco (e.g., in cut filler form), surrounded by a paper wrapper, thereby forming a so-called “smokable rod”, “tobacco rod” or “cigarette rod.” Normally, such a cigarette has a cylindrical filter element aligned in an end-to-end relationship with the tobacco rod. Preferably, a filter element comprises plasticized cellulose acetate tow circumscribed by a paper material known as “plug wrap.” Preferably, the filter element is attached to one end of the tobacco rod using a circumscribing wrapping material known as “tipping paper.” It also has become desirable to perforate the tipping material and plug wrap, in order to provide dilution of drawn mainstream smoke with ambient air. Descriptions of cigarettes and the various components thereof are set forth in Tobacco Production, Chemistry and Technology, Davis et al. (Eds.) (1999); which is incorporated herein by reference. A traditional type of cigarette is employed by a smoker by lighting one end of the tobacco rod. The smoker then receives mainstream smoke into his/her mouth by drawing on the opposite end (e.g., the filter end or mouth end) of the burning cigarette.

Through the years, efforts have been made to improve upon the components, construction and performance of smoking articles that require combustion of tobacco for smoke generation. Many of the improvements that have been proposed purportedly attempt to provide the sensations associated with cigarette, cigar or pipe smoking, but without delivering considerable quantities of incomplete combustion and pyrolysis products that result from burning tobacco. See, for example, the various references in the cited in the background art that is discussed in U.S. Pat. No. 7,753,056 to Borschke et al.; which is incorporated herein by reference.

Certain types of cigarettes that employ carbonaceous fuel elements have been commercially marketed under the brand names “Premier” and “Eclipse” by R. J. Reynolds Tobacco Company. See, for example, those types of cigarettes described in Chemical and Biological Studies on New Cigarette Prototypes that Heat Instead of Burn Tobacco, R. J. Reynolds Tobacco Company Monograph (1988) and Inhalation Toxicology, 12:5, p. 1-58 (2000). Additionally, a similar type of cigarette recently has been marketed in Japan by Japan Tobacco Inc. under the brand name “Steam Hot One.” Furthermore, various types of smoking products incorporating carbonaceous fuel elements for heat generation and aerosol formation recently have been set forth in the patent literature. See, for example, the types of smoking products proposed in U.S. Pat. No. 7,836,897 to Borschke et al.; U.S. Pat. No. 8,469,035 to Banerjee et al. and U.S. Pat. No. 8,464,726 to Sebastian et al.; US Pat. Pub. Nos. 2012/0042885 to Stone et al.; 2013/0019888 to Tsuruizumi et al; 2013/0133675 to Shinozaki et al. and 2013/0146075 to Poget et al.; PCT WO Nos. 2012/0164077 to Gladden et al.; 2013/098380 to Raether et al.; 2013/098405 to Zuber et al.; 2013/098410 to Zuber et al. and 2013/104914 to Woodcock; EP 1808087 to Baba et al. and EP 2550879 to Tsuruizumi et al.; which are incorporated herein by reference.

In recent years, there have been proposed numerous smoking products, flavor generators and medicinal inhalers that utilize electrical energy to heat and vaporize volatile materials, or otherwise attempt to provide many of the sensations of smoking, without burning tobacco to any significant degree. See, for example, the various types of aerosol generation devices set forth in the background art described in U.S. Pat. No. 7,726,320 to Robinson et al., and U.S. patent application Ser. No. 13/826,929, filed Mar. 14, 2013, to Ampolini et al. and Ser. No. 14/011,992, filed Aug. 28, 2013, to Davis et al.; which are incorporated herein by reference.

Tobacco also may be enjoyed in a so-called smokeless form. Particularly popular smokeless tobacco products are employed by inserting some form of processed tobacco or tobacco-containing formulation into the mouth of the user. See for example, the types of representative smokeless tobacco products, as well as the various smokeless tobacco formulations, ingredients and processing methodologies, referenced in the background art set forth in U.S. Pat. Pub. Nos. 2011/0303511 to Brinkley et al. and 2013/0206150 to Duggins et al.; which are incorporated herein by reference.

Thus, the electronic coupon may offer such tobacco products or cigarette products to the user through the user application 38, because such products are age-restricted. The age verification process described earlier may ensure that such products are not available to users below the age threshold.

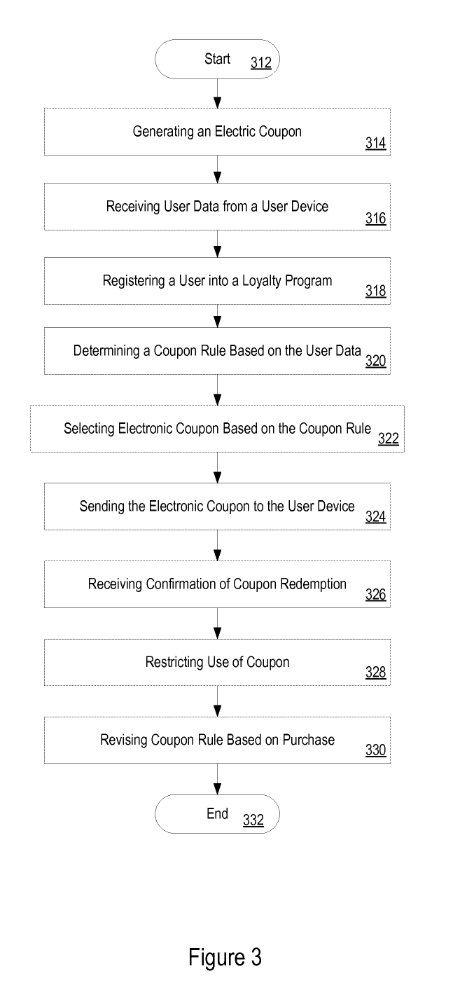

FIG. 3 illustrates a method 300 for improved electronic coupon distribution. The ordering of the steps presented herein is merely one implementation of the method 300. Those skilled in the art will recognize that the ordering may be varied, that some steps may occur simultaneously, that some steps may be omitted, and that further steps may be added.

The method 300 may begin at block 312 and may proceed to block 314. At block 314, an electronic coupon may be generated based on coupon data specified by an electronic coupon issuer. At block 316, user data 26 may be received from a user device 16. The method 300 may proceed from block 316 to block 318. At block 318, a user may be registered into a loyalty program based on the user data 26. The user may be registered into the loyalty program in response to the age satisfying an age criterion (e.g. the age exceeds an age threshold). At block 320, a coupon rule may be determined based on the user data. For example, the coupon rule may be determined based on the one or more of the user's purchase history, browse history, or demographic information. At block 322, an electronic coupon may be selected based on the coupon rule. The electronic coupon may be associated with a product such as a product or service such as a tobacco product. The method 300 may proceed from block 322 to block 324. At block 324, the electronic coupon may be sent to the user device 16. At block 326, a message may be received from the user device 16, where the message confirms that the user redeemed the electronic coupon at a point of sale system 18 to purchase the product. At block 328, a message may be sent to the user device 16, where the message may specify a limitation on further use of the electronic coupon. In some examples, the limitation on further use may be an instruction to expire the electronic coupon. In other examples, the limitation on further use may be an instruction to decrease the number of uses available for the electronic coupon. The method 300 may proceed from block 328 to block 330. At block 330, the coupon rule may be revised based on the purchase of the product associated with the redemption of the electronic coupon. The method 300 may proceed from block 330 to block 332, at which the method 300 may terminate, or may return to block 312, for example.

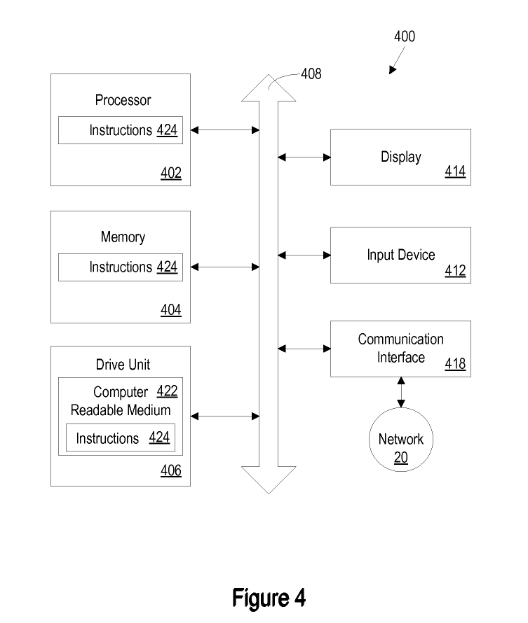

FIG. 4 illustrates a computer system 400, which may represent a loyalty program system 12, an electronic coupon issuer system 14, a user device 16, and/or a point of sale system 18 or any of the other computing devices referenced herein. The computer system 400 may include a set of instructions 424 that may be executed to cause the computer system 400 to perform any one or more of the methods or computer based functions disclosed herein. The computer system 100 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 400 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 424 (sequential or otherwise) that specify actions to be taken by that machine. In a particular embodiment, the computer system 400 may be implemented using electronic devices that provide voice, video or data communication. Further, while a single computer system 400 may be illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, such as, a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 404 may include a cache or random access memory for the processor 402. Alternatively, the memory 404 may be separate from the processor 402, such as a cache memory of a processor, the system memory, or other memory. The memory 404 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 404 may be operable to store instructions 424 executable by the processor 402. The functions, acts or tasks illustrated in the figures or described herein may be performed by the programmed processor 402 executing the instructions 424 stored in the memory 404. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 400 may further include a display 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 412 configured to allow a user to interact with any of the components of computer system 100. The input device 412 may be a number pad, a keyboard, or a cursor control device, such as a mouse, or a joystick, touch screen display, remote control or any other device operative to interact with the computer system 400.

The computer system 400 may also include a disk or optical drive unit 406. The disk drive unit 406 may include a computer-readable medium 422 in which one or more sets of instructions 424, e.g. software, can be embedded. Further, the instructions 424 may perform one or more of the methods or logic as described herein. The instructions 424 may reside completely, or at least partially, within the memory 404 and/or within the processor 402 during execution by the computer system 400. The memory 404 and the processor 402 also may include computer-readable media as discussed above.

The present disclosure contemplates a computer-readable medium 422 (e.g. a non-transitory computer readable medium) that includes instructions 424 or receives and executes instructions 424 responsive to a propagated signal; so that a device connected to the network 20 may communicate voice, video, audio, images or any other data over the network 20. Further, the instructions 424 may be transmitted or received over the network 20 via a communication interface 418. The communication interface 418 may be a part of the processor 102 or may be a separate component. The communication interface 418 may be created in software or may be a physical connection in hardware. The communication interface 418 may be configured to connect with a network 20, external media, the display 414, or any other components in computer system 400, or combinations thereof. The connection with the network 20 may be a physical connection, such as a wired Ethernet connection or may be established wirelessly as discussed below. Likewise, the additional connections with other components of the computer system 400 may be physical connections or may be established wirelessly.

The network 20 may include wired networks, wireless networks, or combinations thereof. The wireless network may be a cellular telephone network, an 802.11, 802.16, 802.20, or WiMax network. Further, the network 20 may be a public network, such as the Internet, a private network, such as an intranet, or combinations thereof, and may utilize a variety of networking protocols now available or later developed including, but not limited to TCP/IP based networking protocols.

The computer-readable medium 422 may be a single medium, or the computer-readable medium 422 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 422 may include a solid-state memory such as a memory card or other package that houses one or more non-volatile read-only memories. The computer-readable medium 422 also may be a random access memory or other volatile re-writable memory. Additionally, the computer-readable medium 422 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

What is claimed is:

1. A computer implemented method comprising:
by at least one processor:
sending to a mobile device an electronic coupon that is selected based on a coupon rule, the electronic coupon being associated with a product;
receiving a first message confirming that the user redeemed the electronic coupon at a point of sale system to purchase the product; and
sending a second message to the mobile device specifying a limitation on further use of the electronic coupon.

2. The computer implemented method of claim 1 further comprising generating the electronic coupon based on coupon data specified by an electronic coupon issuer.

3. The computer implemented method of claim 1 wherein the user data comprises the age, wherein the registering comprises registering the user into the loyalty program in response to the age satisfying an age criterion.

4. The computer implemented method of claim 1 wherein the age satisfying an age criterion comprises the age exceeding an age threshold.

5. The computer implemented method of claim 1 wherein the product comprises a tobacco product.

6. The computer implemented method of claim 1 further comprising determining the coupon rule based on the user data prior to sending to the mobile device the electronic coupon that is selected based on the coupon rule.

7. The computer implemented method of claim 6 further comprising revising the coupon rule based on the purchase of the product associated with the redemption of the electronic coupon.

8. The computer implemented method of claim 6 wherein the user data comprises one or more of the user's purchase history, browse history, or demographic information, wherein determining the coupon rule based on the user data comprises determining the coupon rule based on the one or more of the user's purchase history, browse history, or demographic information.

9. The computer implemented method of claim 1 wherein the limitation on further use comprises an instruction to expire the electronic coupon.

10. The computer implemented method of claim 1 wherein the limitation on further use comprises an instruction to decrease the number of uses available for the electronic coupon.

11. A computer implemented system comprising:
at least one processor operable to:
receive user data from a mobile device;
register a user into a loyalty program based on the user data;
determine a coupon rule based on the user data;
send to the mobile device an electronic coupon that is selected based on the coupon rule, the electronic coupon being associated with a product;
receive from the mobile device a first message confirming that the user redeemed the electronic coupon at a point of sale system to purchase the product; and
send a second message to the mobile device specifying a limitation on further use of the electronic coupon.

12. The computer implemented system of claim 11 wherein the at least one processor is further operable to generate the electronic coupon based on coupon data specified by an electronic coupon issuer.

13. The computer implemented system of claim 11 wherein the user data comprises the age, wherein the at least one processor being operable to register comprises the at least one processor being operable to register the user into the loyalty program in response to the age satisfying an age criterion.

14. The computer implemented system of claim 11 wherein the age satisfying an age criterion comprises the age exceeding an age threshold.

15. The computer implemented system of claim 11 wherein the product comprises a tobacco product.

16. The computer implemented system of claim 11 wherein the at least one processor is further operable to revise the coupon rule based on the purchase of the product associated with the redemption of the electronic coupon.

17. The computer implemented system of claim 11 wherein the user data comprises one or more of the user's purchase history, browse history, or demographic information, wherein the at least one processor being operable to determine the coupon rule based on the user data comprises wherein the at least one processor being operable to determine the coupon rule based on the one or more of the user's purchase history, browse history, or demographic information.

18. The computer implemented system of claim 11 wherein the limitation on further use comprises an instruction to expire the electronic coupon.

19. The computer implemented system of claim 11 wherein the limitation on further use comprises an instruction to decrease the number of uses available for the electronic coupon.

20. A non-transitory computer readable medium, the computer readable medium comprising instructions for:
receiving user data from a mobile device;
registering a user into a loyalty program based on the user data;
sending to the mobile device an electronic coupon that is selected based on a coupon rule, the electronic coupon being associated with a product;
receiving from the mobile device a first message confirming that the user redeemed the electronic coupon at a point of sale system to purchase the product; and
sending a second message to the mobile device specifying a limitation on further use of the electronic coupon.
